(19) United States
(12) Patent Application Publication
(10) Pub. No.: US 2004/0267705 A1
(43) Pub. Date: Dec. 30, 2004

(54) Memory with file deletion system

(76) Inventors: Connie Lemus, Boise, ID (US); Thomas C. Anthony, Sunnyvale, CA (US); Sarah Brandenberger, Boise, ID (US); Colin Stobbs, Eagle, ID (US); Robert Sesek, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/463,375

(22) Filed: Jun. 17, 2003

(51) Int. Cl. G06F 7/00

(52) U.S. Cl. 707/3

(57) ABSTRACT

A memory comprising a storage medium that includes a first file and first information associated with the first file and a controller coupled to the storage medium. The controller is configured to access second information and is configured to cause the first file to be deleted in response to comparing the first information to the second information.

### BACKGROUND OF THE INVENTION

Many electronic devices such as digital cameras, personal and laptop computer systems, personal digital assistants (PDA), televisions, and audio and/or video media players are configured to store information to and retrieve information from memory systems coupled to the devices. These memory systems offer users the ability to store and transfer information between various devices by storing information from one device onto a memory system and transferring the information from the memory system to another device. For example, a user may take pictures using a digital camera that stores the pictures on a memory system. The user may then couple the memory system to a computer system to transfer the pictures from the memory system to the computer system.

Unfortunately, memory systems have a finite capacity, and the information stored on a memory system needs to be managed to ensure that the memory system will be able store new or additional information. Although various compression or other memory management techniques may be used to enhance the amount of information that may be stored on a given memory system, these techniques typically require some level of advanced interaction with a user. Further, these techniques may not free up sufficient memory space to meet a user's needs.

### SUMMARY OF THE INVENTION

One embodiment of the present invention provides a memory comprising a storage medium comprising a first file and first information associated with the first file and a controller coupled to the storage medium. The controller is configured to access second information and is configured to cause the first file to be deleted in response to comparing the first information to the second information.

### BRIEF DESCRIPTION OF THE DRAWINGS

FIG. 1 is block diagram illustrating an embodiment of a system for deleting expired data from a memory.

FIG. 2 is a flow chart illustrating an embodiment of a method for deleting expired data from a memory.

FIG. 3 is block diagram illustrating a first example of information stored on a storage medium.

FIG. 4 is block diagram illustrating a second example of information stored on a storage medium.

### DETAILED DESCRIPTION

Embodiments of the invention are better understood with reference to the following drawings. The elements of the drawings are not necessarily to scale relative to each other. Like reference numerals designate corresponding similar parts.

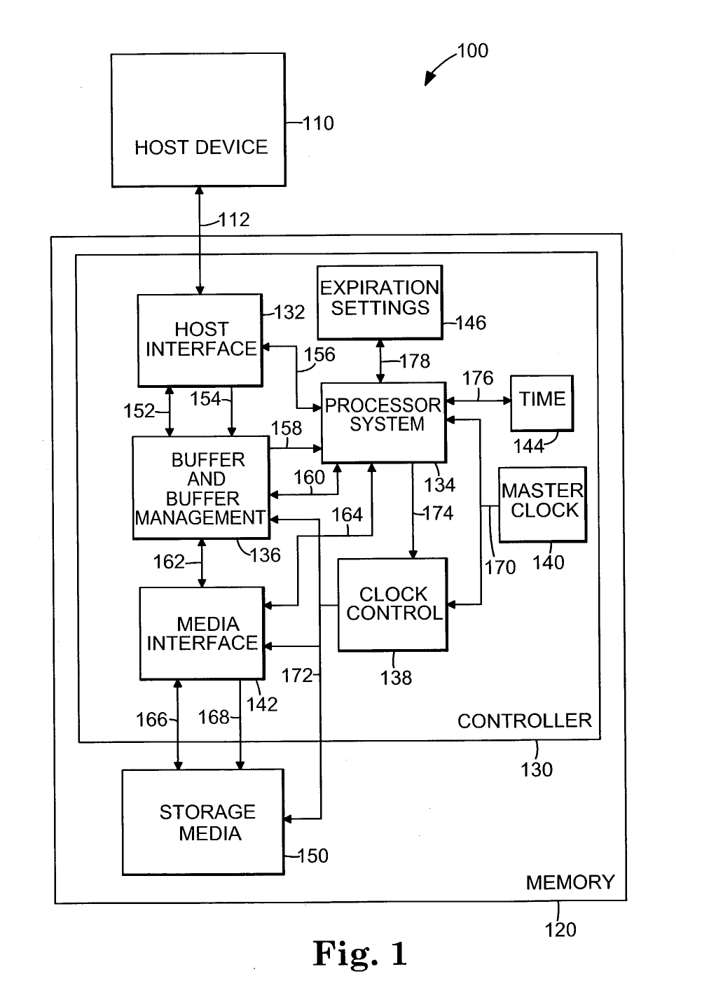

FIG. 1 is a block diagram illustrating an embodiment of a system 100 that includes a memory 120 coupled to a host device 110. As will be described in additional detail herein below, memory 120 is configured to delete expired files.

Memory 120 includes a controller 130 and storage media 150. Controller 130 includes a host interface 132, a processor system 134, a buffer and buffer management circuit 136, a clock control circuit 138, a master clock 140, a media interface 142, time information 144, and expiration settings 146. Storage media 150 includes at least one storage medium configured to store information and may include any type or combination of non-volatile electrical, magnetic, or optical storage media such as flash memory, magnetic RAM (MRAM), atomic resolution storage (ARS), or magnetic or optical disks. The components within controller 130 may each include hardware, software, or a combination of hardware and software.

Memory 120 may be any type of non-volatile storage device that is configured to store information. For example, memory 120 may be any type of memory card such as a CompactFlash™ memory card, a SmartMedia™ memory card, a MultiMediaCard™ memory card, a Secure Digital memory card, or a Memory Stick™ memory card. Memory 120 may also be a magnetic or optical disk drive such as a hard disk drive or any type of CD or DVD drive. Memory 120 may be detached or removed from host device 110 and used with other host devices (not shown).

In operation, host device 110 provides information to memory 120 over host interface lines 112. The information includes transactions such as read and write transactions, commands, a host clock signal, and other information. The information is received using host interface 132 and may be stored into the buffer in buffer and buffer management circuit 136 using data lines 152 and host clock line 154. Processor system 134 provides control signals to and receives information from host interface 132 using host interface lines 156. Processor system 134 also provides control signals to and receives information from the buffer using buffer control lines 160. Buffer and buffer management circuit 136 provides a buffer empty/buffer full signals to processor system 134 using one or more lines 158. In response to control signals from processor system 134, buffer and buffer management circuit 136 provides information to media interface 142 using data lines 162. Media interface 142 provides the information and media control signals to storage media 150 using data lines 166 and control lines 168, respectively. Processor system 134 provides control signals to and receives information from media interface 142 using media interface control lines 164.

Master clock 140 generates a master clock signal at a master clock rate and provides the master clock signal to processor system 134 and clock control circuit 138. Processor system 134 provides control signals to clock control circuit 138 using a media clock control line 174. Clock control circuit provides a media clock signal at a media clock rate to buffer and buffer management circuit 136, media interface 142, and storage media 150 using lines 172.

Controller 130 is configured to cause expired files to be deleted from memory 120 using processor system 134, time information 144 and expiration settings 146. Expiration settings 146 may be stored in response to an indication or indications from a user of host device 110 and/or memory 120. For example, controller 130 may cause a file expiration mode to be activated or deactivated in response to an indication from the user to cause expired files to be deleted. In addition, controller 130 may cause a query user mode to be activated or deactivated in response to an indication from the user to cause the user to be prompted as to whether or not to delete expired files. Further, controller 130 may allow a user to select a write protect option to prevent one or more files from being deleted regardless of any expiration status. In response to a user providing the write protection option for the file, controller 130 causes an indication to be stored along with the file to indicate that the file is not to be deleted.

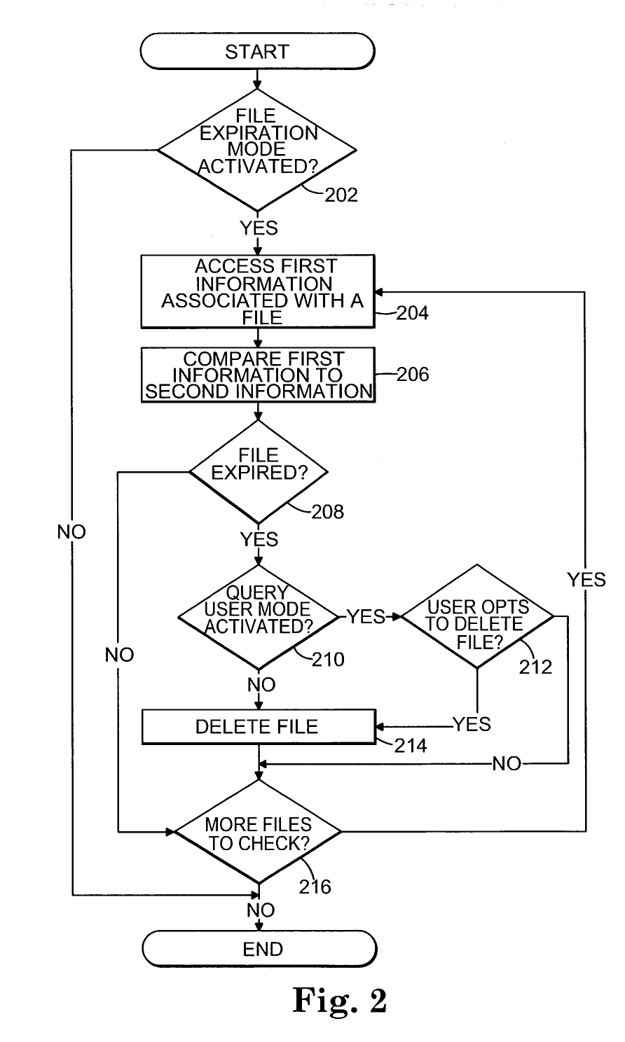

The operation of controller 130 will be described with reference to FIG. 2. FIG. 2 illustrates an embodiment of a method for deleting expired files. As shown in FIG. 2, a determination is made as to whether a file expiration mode is activated as indicated in a block 202. The file expiration mode of memory 120 may be set by default or may be activated or deactivated in response to an indication from the user of host device 110 and/or memory 120. If the file expiration mode is not activated, then the method ends as shown.

If the file expiration mode is activated, then first information associated with a file is accessed as indicated in a block 204. The first information is compared to second information as indicated in a block 206.

A determination is made as to whether the file has expired as indicated in a block 208. The determination is based on the comparison made in block 206. If the file has not expired, then the method continues at a block 216 as described below.

If the file has expired then a determination is made as to whether a query user mode is activated as indicated in a block 210. The query user mode of memory 120 may be set by default or may be activated or deactivated in response to an indication from the user of host device 110 and/or memory 120. If the query user mode is activated, then a determination is made as to whether the user opts to delete the file as indicated in a block 212. To determine whether a user opts to delete the file, controller 130 may cause the user to be prompted to determine whether the user wants to delete the file. If the user chooses to delete the file, then the file is deleted as indicated in a block 214. If the user chooses not to delete the file, then the file is not deleted as the method continues at block 216.

If the query user mode is not activated, then the file is deleted as indicated in block 214. In other words, the file is deleted without first prompting the user to determine whether the user wishes to delete the file.

A determination is made as to whether there are more files to check as indicated in block 216. If there are more files to check, then the method repeats beginning at block 204. If there are no more files to check, then the method ends as shown.

In an alternative embodiment of the method, the file may be compressed in block 214 instead of being deleted. Where the query user mode is activated, the user may opt to compress or not compress the file in block 212.

In yet another embodiment of the method, the user may be given the option to either delete or compress the file in block 212. In this embodiment, the file is either deleted, compressed or left unchanged in response to a selection by the user.

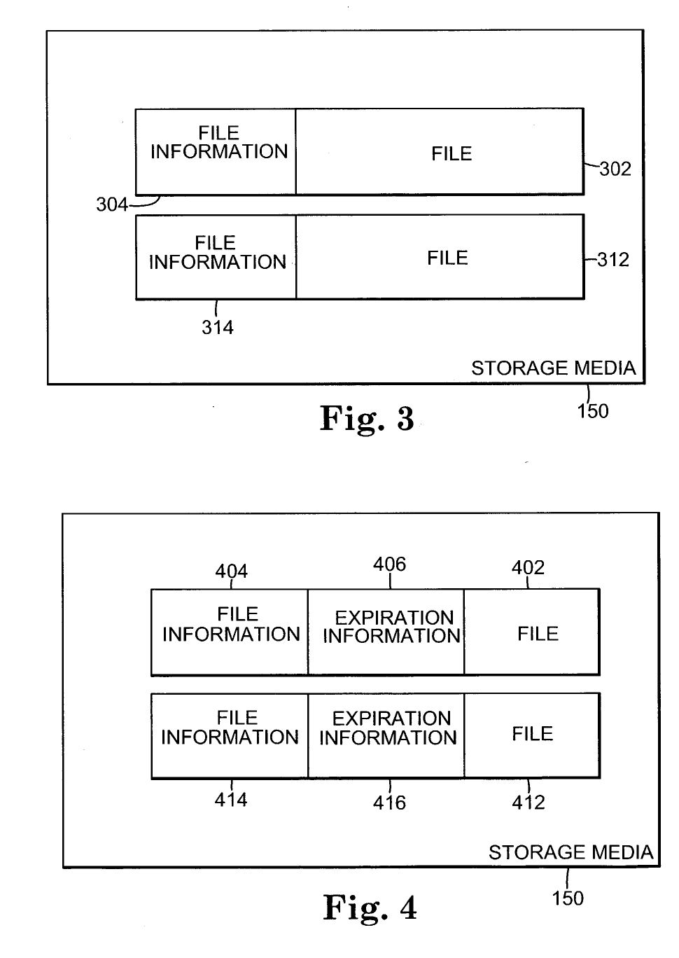

In a first embodiment of the method shown in FIG. 2, the first information referenced in blocks 204 and 206 includes a file date stored along with the file on storage media 150 as illustrated in FIG. 3. In FIG. 3, storage media 150 includes a file 302 along with associated file information 304 and a file 312 along with associated file information 314. File information 304 and file information 314 each include one or more file dates such as a file creation date and a file modification date and may also include other information associated with files 302 and 312, respectively.

In this embodiment, the second information includes an expiration date stored in expiration settings 146. Processor system 134 calculates the expiration date using information from expiration settings 146 and time information 144. In particular, processor system 134 calculates the expiration date in response to the expiration information and the current date.

Processor system 134 causes the expiration date to be stored within expiration settings 146 or in another suitable location such as a register or storage media 150. The information from expiration settings 146 used to calculate the expiration date may be set by default or provided by the user. For example, the user may select an expiration setting of six months indicating that all files that are older than six months should be deleted. Using this information and a current date from time information 144, processor system 134 calculates an expiration date as a date six months prior to the current date. Thus, if the current date is Nov. 25, 2002, then the expiration date would be calculated to be May 25, 2002 in this example.

Controller 130 determines whether a file has been expired in this embodiment by determining whether a file date associated with a file is prior to or the same as the expiration date. The file date used may be a file creation date, a file modification date, or other date associated with the file. Accordingly, to determine whether file 302 in the embodiment shown in FIG. 3 has expired, processor system 134 accesses a file date from file information 304 and compares the file date to the expiration date. If the file date is prior to or the same as the expiration date, then file 302 has expired and may be deleted as described in the method of FIG. 2 above. If the file date is subsequent to the expiration date, then file 302 has not expired and will not be deleted. In addition, if the file has a write protection indication stored as part of the file information, then the file will not be deleted regardless of any expiration date. The same process may be applied to file 312 using the file date in file information 314. As a variation, a file may be considered expired only if its file date is prior to the expiration date, i.e. a file will not be considered to be expired if the file date is the same as the expiration date.

In a second embodiment of the method shown in FIG. 2, the first information referenced in blocks 204 and 206 includes an expiration date stored along with the file on storage media 150 as illustrated in FIG. 4. In FIG. 4, storage media 150 includes a file 402 along with associated file information 404 and expiration information 406. Storage media 150 also includes a file 412 along with associated file information 414 and expiration information 416. File information 404 and file information 414 may each include one or more file dates such as a file creation date and a file modification date and may also include other information associated with files 402 and 412, respectively. Expiration information 406 and expiration information 416 each include an expiration date and may include additional information such as a write protect indication.

In this embodiment, the expiration date associated with a file is calculated and stored in response to a file being stored or modified. Processor system 134 calculates the expiration date using information from expiration settings 146 and time information 144. The information from expiration settings 146 used to calculate the expiration date may be set by default or provided by the user. For example, the user may select an expiration setting of six months indicating that a file is to be deleted six months from being created or modified. Using this information and a current date from time information 144, processor system 134 calculates an expiration date as a date six months subsequent to the date that the file is created or modified. Thus, if the file is created or modified on Nov. 25, 2002, then the expiration date would be calculated to be May 25, 2003 and stored in the expiration information along with the file in this example.

The expiration date in this embodiment may also be an absolute time expiration date. In particular, an absolute expiration date may be entered by a user and stored for each file. For example, a user may enter an expiration date for a particular file as Jun. 1, 2007.

The second information in this embodiment is the current date stored in time information 144. Controller 130 determines whether a file has been expired in this embodiment by determining whether an expiration date associated with a file is prior to or the same as the current date. Accordingly, to determine whether file 402 in the embodiment shown in FIG. 4 has expired, processor system 134 accesses the expiration date from expiration information 406 and compares the expiration date to the current date accessed from time information 144. If the expiration date is prior to or the same as the current date, then the file has expired and may be deleted as described in the method of FIG. 2 above. If the expiration date is subsequent to the current date, then the file has not expired and will not be deleted. In addition, if the file has a write protection indication, then the file will not be deleted regardless of any expiration date that may be stored with the file. As a variation, a file may be considered expired only if its expiration date is prior to the current date, i.e. a file will not be considered to be expired if the expiration date is the same as the current date.

In each of the above embodiments, information may be stored in locations other than those shown in FIGS. 1, 3, and 4. In particular, time information 144 and/or expiration settings 146 may be stored in storage media 150 or on a device external to memory 120 such as host device 110. In cases where time information 144 and/or expiration settings 146 are stored external to memory 120, memory 120 is configured to access time information 144 and/or expiration settings 146 from the external device such as host device 110.

Although the above embodiments have been discussed using real time values (e.g., Nov. 25, 2002), other ways of measuring time may be used, particularly where memory 120 may not have access to real time information. For example, a file may be deleted after a set number of times memory 120 is accessed or powered on. In addition, memory 120 may internally calculate an elapsed time and set the expiration settings to cause a file to be deleted after a certain amount of time has elapsed.

What is claimed is:

1. A memory comprising:
a storage medium comprising a first file and first information associated with the first file; and
a controller coupled to the storage medium;
wherein the controller is configured to access second information, and wherein the controller is configured to cause the first file to be deleted in response to comparing the first information to the second information.

2. The memory of claim 1 wherein the first information comprises a first file date, wherein the second information comprises an expiration date, and wherein the controller causes the first file to be deleted in response to the first file date being prior to or the same as the expiration date.

3. The memory of claim 2 wherein the controller accesses a current date and an expiration setting, and wherein the controller calculates the expiration date in response to the current date and the expiration setting.

4. The memory of claim 2 wherein the storage medium comprises a second file and third information associated with the second file, and wherein the controller causes the second file not to be deleted in response to comparing the third information to the second information.

5. The memory of claim 4 wherein the third information comprises a second file date, and wherein the controller causes the second file not to be deleted in response to the second file date being subsequent to the expiration date.

6. The memory of claim 1 wherein the first information comprises a first expiration date, wherein the second information comprises a current date, and wherein the controller causes the first file to be deleted in response to the first expiration date being prior to or the same as the current date.

7. The memory of claim 6 wherein the controller causes the first expiration date to be stored in the storage medium in response to storing the first file.

8. The memory of claim 1 wherein the controller causes a user to be prompted as to whether to delete the first file in response to comparing the first information to the second information.

9. The memory of claim 1 wherein the controller causes the first file to be deleted in response to comparing the first information to the second information and in response to a file expiration mode being active.

10. The memory of claim 1 wherein the controller causes the first file to be deleted in response to comparing the first information to the second information and in response to a write protection indication associated with the first file not being present.

11. A system comprising:
a host device; and
a memory coupled to the host device;
wherein the memory is configured to store a file and first information associated with the file received from the host device, wherein the memory is configured to access second information, and wherein the memory is configured to delete the file in response to comparing the first information to the second information.

12. The system of claim 11 wherein the second information is stored within the memory.

13. The system of claim 11 wherein the memory receives the second information from the host device.

14. The system of claim 11 wherein the first information comprises a file date, wherein the second information comprises an expiration date, and wherein the memory deletes the file in response to the file date being prior to or the same as the expiration date.

15. The system of claim 11 wherein the first information comprises an expiration date, wherein the second information comprises a current date, and wherein the memory deletes the file in response to the expiration date being prior to or the same as the current date.

16. A method comprising:
providing a memory that comprises a file and first information associated with the file;
comparing the first information to second information; and
compressing the file in response to comparing the first information to the second information.

17. The method of claim 16 further comprising:
comparing the first information that comprises a file date to the second information that comprises an expiration date; and
compressing the file in response to the file date being prior to or the same as the expiration date.

18. The method of claim 17 further comprising:
accessing a current date and an expiration setting; and
calculating the expiration date in response to the current date and the expiration setting.

19. The method of claim 16 further comprising:
comparing the first information that comprises an expiration date to the second information that comprises a current date; and
compressing the file in response to the expiration date being prior to or the same as the current date.

20. The method of claim 19 further comprising:
storing the file; and
storing the expiration date in response to storing the file.

21. The method of claim 16 further comprising:
causing a user to be prompted as to whether to compress the file in response to comparing the first information to the second information.
